(19) United States
(12) Patent Application Publication
(10) Pub. No.: US 2011/0304547 A1
(43) Pub. Date: Dec. 15, 2011

(54) PLANARIZED LASER MOUSE

(75) Inventor: Huo-Lu Tsai, Ta Ya Shiang (TW)

(73) Assignee: Sunrex Technology Corp., Ta Ya Shiang (TW)

(21) Appl. No.: 12/797,634

(22) Filed: Jun. 10, 2010

(51) Int. Cl. G09G 5/08

(52) U.S. Cl. 345/166

(57) ABSTRACT

A planarized laser mouse includes left and right base plates; insulative left and right plate members on the left and right base plates respectively, each plate member comprising stop and retaining grooves; left and right scissor-shaped structure assemblies each having at least one scissor-shaped structure pivotably secured to the stop grooves and the first retaining grooves of the left and right membrane plates beneath respectively; and left and right buttons each comprising, on a bottom, a plurality of pivot grooves, a plurality of second retaining grooves, and a central pressing member aligned with the recess of the elastic member, wherein the pivot and second retaining grooves of the left and right buttons are pivotably secured to the at least one scissor-shaped structure of the left and right scissor-shaped structure assemblies beneath respectively.

### BACKGROUND OF THE INVENTION

1. Field of Invention

The invention relates to computer mice and more particularly to a planarized laser mouse.

2. Description of Related Art

Mice are widely employed by desktop computers or laptops. A mouse is a computer input device that is used by moving it around on the desk and pressing one or more buttons. Moving the mouse moves a pointer on the screen. Graphical user interfaces such as Microsoft Windows operating system are built around the mouse. Some software programs such as paint and draw programs are also built around the mouse.

A computer mouse disclosed by Taiwanese Utility Model Patent No. M375,930 is characterized in that a casing has a convex top and a flat bottom, two parallel buttons are on a front portion of the top, each button being electrically connected to a respective switch, and a scroll wheel is disposed between the buttons. A user may rotate the scroll wheel to drag a pointer on the screen.

However, the typical mouse is not flat. Further, it can make noise when its button is pressed. Thus, the need for improvement still exists.

### SUMMARY OF THE INVENTION

It is therefore one object of the invention to provide a planarized laser mouse comprising a casing; left and right base plates in the casing; insulative left and right plate members disposed on the left and right base plates respectively, each of the left and right plate members comprising a plurality of stop grooves and a plurality of retaining grooves; left and right membrane circuit boards disposed on the left and right plate members, each of the left and right membrane circuit boards comprising a contact; left and right membrane plates disposed on the left and right membrane circuit boards respectively, each of the left and right membrane plates comprising an elastic member including a top recess and a conductive bottom stem aligned with the contact beneath; left and right scissor-shaped structure assemblies each having at least one scissor-shaped structure pivotably secured to the stop grooves and the first retaining grooves of the left and right membrane plates beneath respectively; and left and right buttons each comprising, on a bottom, a plurality of pivot grooves, a plurality of second retaining grooves, and a central pressing member aligned with the recess of the elastic member, wherein the pivot and second retaining grooves of the left and right buttons are pivotably secured to the at least one scissor-shaped structure of the left and right scissor-shaped structure assemblies beneath respectively.

The above and other objects, features and advantages of the invention will become apparent from the following detailed description taken with the accompanying drawings.

### BRIEF DESCRIPTION OF THE DRAWINGS

FIG. 1 is a perspective view of a planarized laser mouse according to the invention;

FIG. 2 is an exploded perspective view of FIG. 1;

FIG. 3 is an exploded view of parts between one button and the base plate of FIG. 1;

FIG. 4 is a plan view of the assembled button and U-bar in FIG. 3;

FIG. 5 is a perspective view of the scissor-shaped structure;

FIG. 6 is a sectional view taken along lines A-A of FIG. 1; and

FIG. 7 is a view similar to FIG. 6 showing the button being pressed by a finger (not shown).

### DETAILED DESCRIPTION OF THE INVENTION

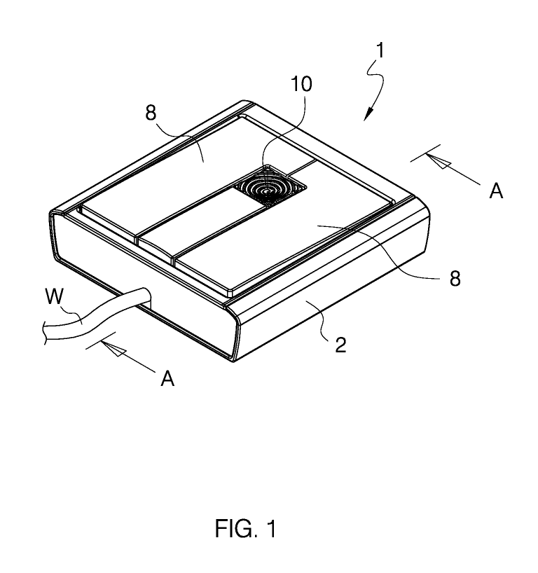

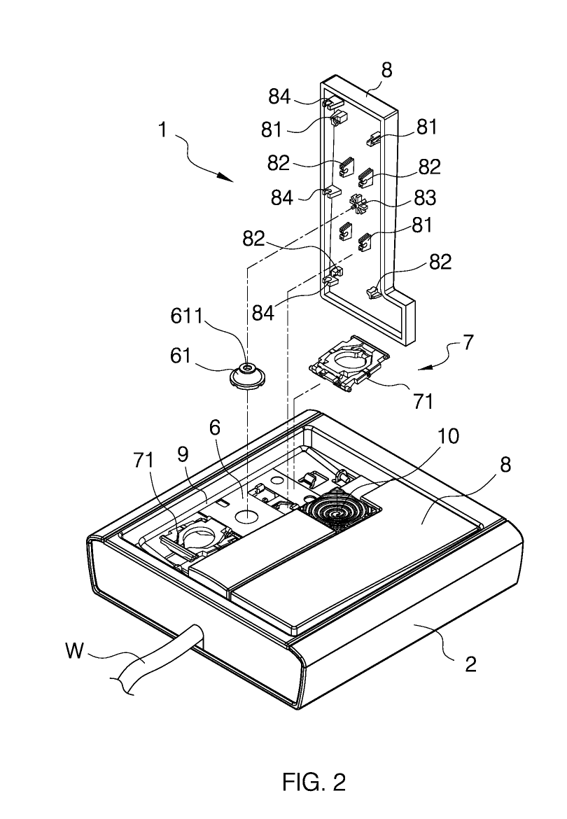

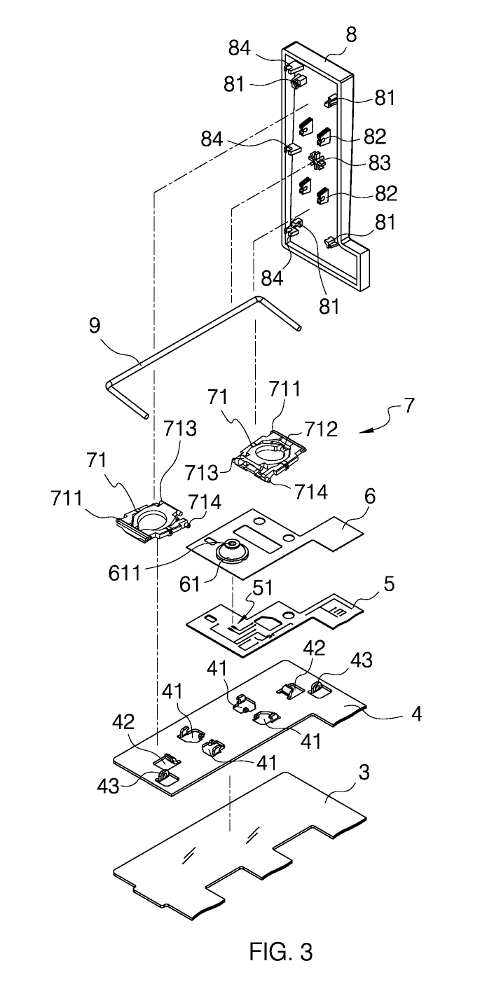

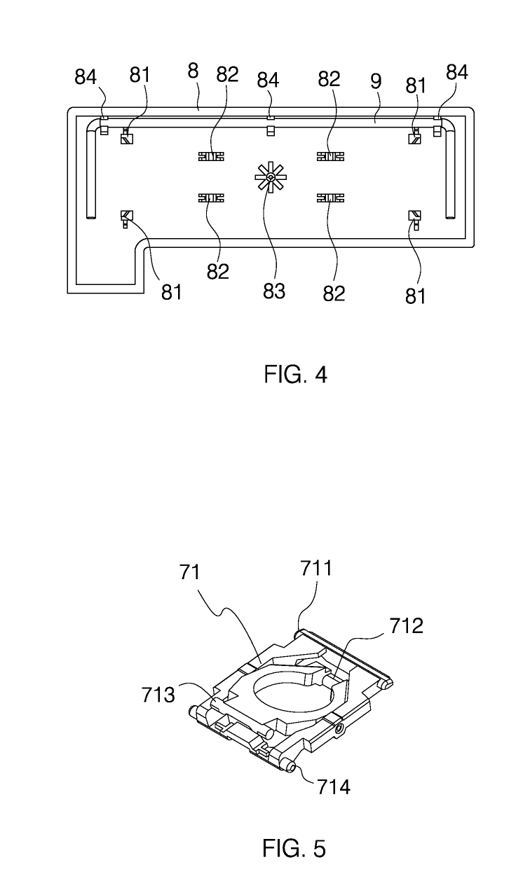

Referring to FIGS. 1 to 7, a planarized laser mouse 1 in accordance with the invention comprises the following components as discussed in detail below.

A rectangular casing 2 has a standard USB (Universal Serial Bus) protocol based connector which is electrically connected to, for example, a desktop computer (not shown) via a cord W extending from a rear end. While the casing 2 is relatively flat, other ergonomic shapes are also contemplated by the invention.

Within a lower portion of the casing 2 there are provided an IR (infrared) laser diode (R) for illuminating the supporting surface beneath and associated components.

Within an upper portion of the casing 2, from bottom to top, there are provided the following components. Left and right base plates 3 are provided. Left and right plate members 4 made of insulative material are provided on the left and right base plates 3 respectively. Each plate member 4 comprises front and rear stop grooves 43, two snapping grooves 42 each adjacent the front or rear stop groove 43, and four intermediate retaining grooves 41 arranged as four corner of a virtual rectangle.

Left and right membrane circuit boards 5 provided on the left and right plate members 4 respectively but are offset with respect to the retaining grooves 41 and the snapping grooves 42, i.e., not in covering relation to the retaining grooves 41 and the snapping grooves 42. Each of the left and right membrane circuit boards 5 has a contact 51 and electronics (not numbered). Left and right membrane plates 6 are provided on the left and right membrane circuit boards 5 respectively. Each of the left and right membrane plates 6 comprises a dome-shaped elastic member 61 including a cup-shaped top recess 611 aligned with the contact 51 beneath, and a bottom stem 62 formed of conductive material.

Left and right scissor-shaped structure assemblies 7 each having two scissor-shaped structures 71 are provided. The scissor-shaped structure 71 has a section of “X” and comprises two first slide axles 714 at two corners of one end of a first frame (not numbered), a second slide axle 713 at one end of a second frame (not numbered) pivotal about the first frame at its central axis, a first pivot shaft 711 at the other end of the first frame, a second pivot shaft 712 at the other end of the first frame parallel to and below the first pivot shaft 711, and a central circular hole (not numbered).

Left and right buttons 8 each comprises, on its bottom, front and rear pairs of pivot grooves 81, front, intermediate, and rear fastening grooves 84 along one side, a central pressing member 83 transversely aligned with the intermediate fastening groove 84, two spaced retaining grooves 82 between the front pair of pivot grooves 81 and the pressing member 83, and two spaced retaining grooves 82 between the rear pair of pivot grooves 81 and pressing member 83. A U-bar 9 is mounted on the bottom of the button 8 by securing to the front, intermediate, and rear fastening grooves 84. The U-bar 9 functions as a weight of the button 8 so that the button 8 can be disposed in a balanced state without vibration when being pressed.

A rectangular knurled member 10 is provided between the right and left buttons 8. A user may press and push the knurled member 10 for dragging the mouse 1 on the supporting surface.

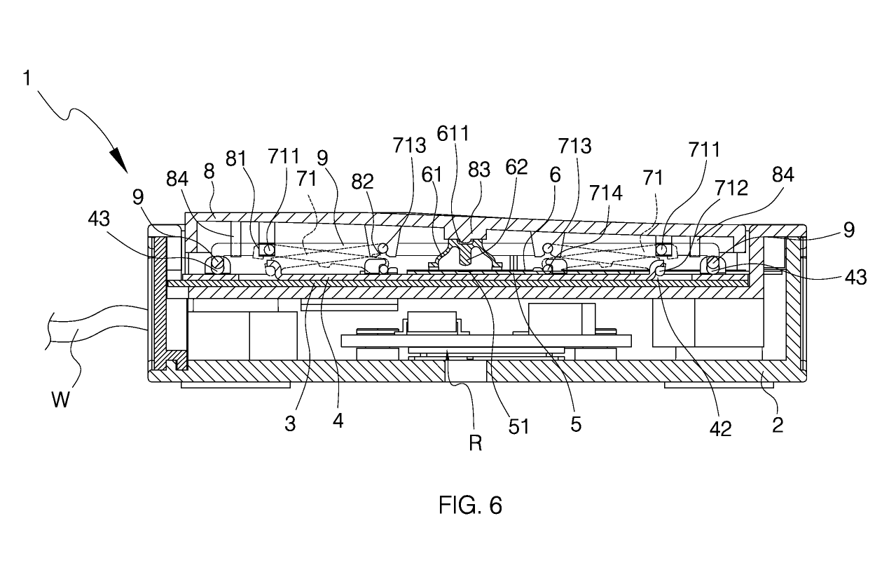

As shown in FIG. 6, the bottom end of the pressing member 83 is fitted in the recess 611 for positioning, two ends of the U-bar 9 are fastened in the stop grooves 43, the first pivot shaft 711 is pivotably secured to the pivot grooves 81, the first slide axles 714 are pivotably secured to the retaining grooves 41 respectively, the second slide axle 713 is pivotably secured to the retaining grooves 82, and the second pivot shaft 712 is pivotably secured to the snapping groove 42.

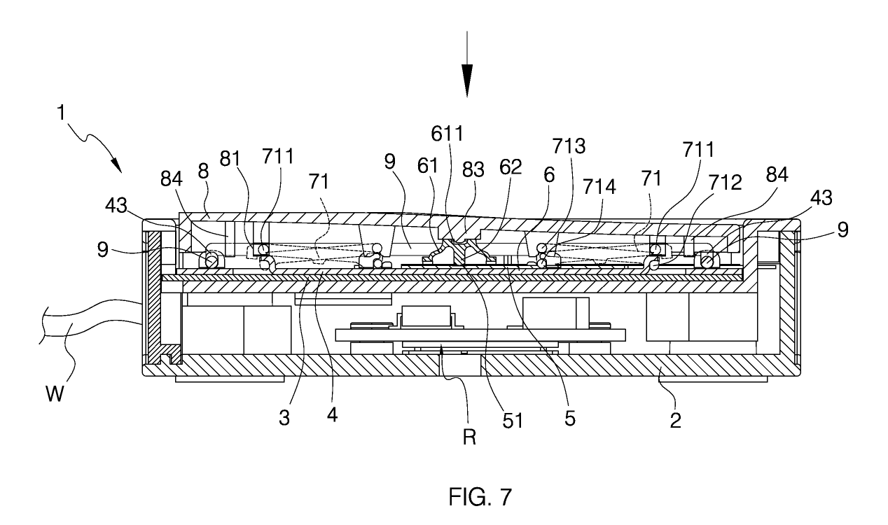

In use (see FIG. 7), a user may press either button 8 to push down the pressing member 83 and thus the stem 62 with the elastic member 61 being elastically compressed and both the scissor-shaped structures 71 under the depressed button 8 being pivoted. Thus, the downward moving stem 62 may electrically connect to the contact 51 if the pressing of the button 8 continues. As a result, a button switch corresponding to the depressed button 8 is “closed”. It is understood that a release of the button 8 will elastically return the button 8 to its rest position.

The invention has the following advantages: It is relatively flat. This can facilitate dragging movement of the mouse. Further, the double scissor-shaped structure arrangement under each button can minimize the generation of noise. This is particularly beneficial when an individual operates a computer in the night.

While the invention has been described in terms of preferred embodiments, those skilled in the art will recognize that the invention can be practiced with modifications within the spirit and scope of the appended claims.

What is claimed is:

1. A planarized laser mouse comprising:
a casing;
left and right base plates in the casing;
insulative left and right plate members disposed on the left and right base plates respectively, each of the left and right plate members comprising a plurality of stop grooves and a plurality of first retaining grooves;
left and right membrane circuit boards disposed on the left and right plate members, each of the left and right membrane circuit boards comprising a contact;
left and right membrane plates disposed on the left and right membrane circuit boards respectively, each of the left and right membrane plates comprising an elastic member including a top recess and a conductive bottom stem aligned with the contact beneath;
left and right scissor-shaped structure assemblies each having at least one scissor-shaped structure pivotably secured to the stop grooves and the first retaining grooves of the left and right membrane plates beneath respectively; and
left and right buttons each comprising, on a bottom, a plurality of pivot grooves, a plurality of second retaining grooves, and a central pressing member aligned with the recess of the elastic member,
wherein the pivot and second retaining grooves of the left and right buttons are pivotably secured to the at least one scissor-shaped structure of the left and right scissor-shaped structure assemblies beneath respectively.

2. The planarized laser mouse of claim 1, wherein each of the left and right buttons further comprises, on the bottom, a plurality of fastening grooves along one side, and a U-bar releasably secured to the fastening grooves.

3. The planarized laser mouse of claim 1, wherein each scissor-shaped structure comprises two first slide axles at one end, a second slide axle above the first slide axles, a first pivot shaft at the other end, and a second pivot shaft at the other end beneath the first pivot shaft, and wherein the first pivot shaft is pivotably secured to the pivot grooves, the first slide axles are pivotably secured to the first retaining grooves respectively, the second slide axle is pivotably secured to the second retaining grooves, and the second pivot shaft is pivotably secured to the snapping groove.

4. The planarized laser mouse of claim 1, further comprising a knurled member between the right and left buttons.

5. The planarized laser mouse of claim 1, further comprising an IR (infrared) laser diode under the left and right base plate, the IR laser diode being adapted to downward emit IR rays.
